(19) United States
(12) Patent Application Publication
(10) Pub. No.: US 2002/0067101 A1
(43) Pub. Date: Jun. 6, 2002

(54) MOTOR VEHICLE ALTERNATOR WITH PERMANENT MAGNETS

(76) Inventors: PAUL ARMIROLI, MAROLLES EN BRIE (FR); JEAN PHILIPPE BADEY, ETAPLES (FR); DENIS GRAVAT, LA FERTE GAUCHER (FR)

Correspondence Address: JOSEPH A CALVARUSO ESQ, MORGAN & FINNEGAN L L P, 345 PARK AVENUE, NEW YORK, NY, 101540053

(21) Appl. No.: 09/411,580

(22) Filed: Oct. 1, 1999

(30) Foreign Application Priority Data
Oct. 2, 1998 (FR) 98 12360

(51) Int. Cl. H02K 1/22

(52) U.S. Cl. 310/263

(57) ABSTRACT

The alternator for a vehicle includes two magnet wheels (6) comprising poles (10) in the form of interlaced claws and at least one magnet (20) interposed between the poles. Each magnet (20) comprises two parts fixed to one another by a layer (26) of material which is more flexible than the magnet.

### FIELD OF THE INVENTION

The invention relates to the alternators of vehicles, particularly motor vehicles.

### BACKGROUND OF THE INVENTION

An alternator for a vehicle is known from the document EP-0 762 617 A1, comprising magnet wheels having poles in the form of interlaced claws, and inter-pole permanent magnets interposed between the adjacent claws. The magnets reduce the leakages of magnetic flux and contribute to reinforcing the magnetic flux. When the manufacturing tolerances of the pieces are relatively wide in order to reduce costs, it may happen that an inter-pole magnet breaks under the effect of the centrifugal forces and of the considerable heating engendered by the rotation of the rotor at high speed (opening of the pole horns).

One object of the invention is to supply an alternator allowing the magnets to be fixed while reducing, among other things, the risk of breaking the magnet, without requiring very fine manufacturing tolerances.

### SUMMARY OF THE INVENTION

According to the present invention there is provided an alternator for a vehicle comprising two magnet wheels comprising poles in the shape of interlaced claws, and a magnet interposed between the poles, wherein the magnet comprises two parts fixed to one another by a layer of material which is more flexible than the magnet.

Hence, because of its flexibility, the layer of material takes up the play due to the manufacturing tolerances and absorbs the deformations of the pieces which are due to the heating and to the forces which are generated by the high speeds. This reduces the risk of breaking the magnet. What happens is that, with the magnet being bonded to a pole horn, the relative movement of each pole horn, and thus of the magnet, is absorbed by the flexible material.

Advantageously, the material comprises iron.

Hence, the continuity of the magnetic field through the layer of flexible material is enhanced.

Advantageously, the magnet extends between lateral faces of the associated poles, the layer of flexible material extending along a plane parallel to the lateral faces of the poles.

Advantageously, the layer of flexible material extends at mid-distance from the associated poles.

Advantageously, the layer of flexible material extends along a median plane of the magnet perpendicular to a direction of polarization of the magnet.

Advantageously, the poles exhibit lateral faces in which are formed grooves in which the magnet is accommodated.

Advantageously, the grooves have a “U”-shaped profile.

Hence, a magnet with a rectangular profile can be accommodated between the poles.

Advantageously, the grooves have a “V”-shaped transverse profile, one branch of the “V” being generally parallel to a circumferential face of the pole.

Hence, a magnet with a trapezoidal profile can be accommodated between the poles.

Advantageously, the poles have inner and outer circumferential faces and lateral faces each uninterrupted from one to the other of the circumferential faces and inclined towards a shaft of the alternator.

Hence, these faces delimit a trapezoidal housing in which a magnet with a trapezoidal profile can be accommodated, which can be arranged very close to the gap, having regard to the absence of a return under the magnet close to the gap.

Advantageously, the magnet has a rectangular profile perpendicularly to a longitudinal direction of the magnet.

Advantageously, the magnet is bonded to at least one of the poles by means of an adhesive identical to the material.

Advantageously, the alternator comprises several magnets, at least two of the magnets, or even most of them, preferably all of them, each comprising two separate parts.

Advantageously, the magnet has a trapezoidal profile perpendicularly to a longitudinal direction of the magnet.

### BRIEF DESCRIPTION OF THE DRAWINGS

Other characteristics and advantages of the invention will further emerge in the following description of a preferred embodiment and of variants given by way of non-limiting examples. In the attached drawings:

FIG. 1 is a partial side view of an alternator rotor according to the invention;

FIG. 2 is a partial view in section along the line II-II of the rotor of FIG. 1; and

FIGS. 3, 4 and 5 are views similar to FIG. 2 illustrating variant embodiments.

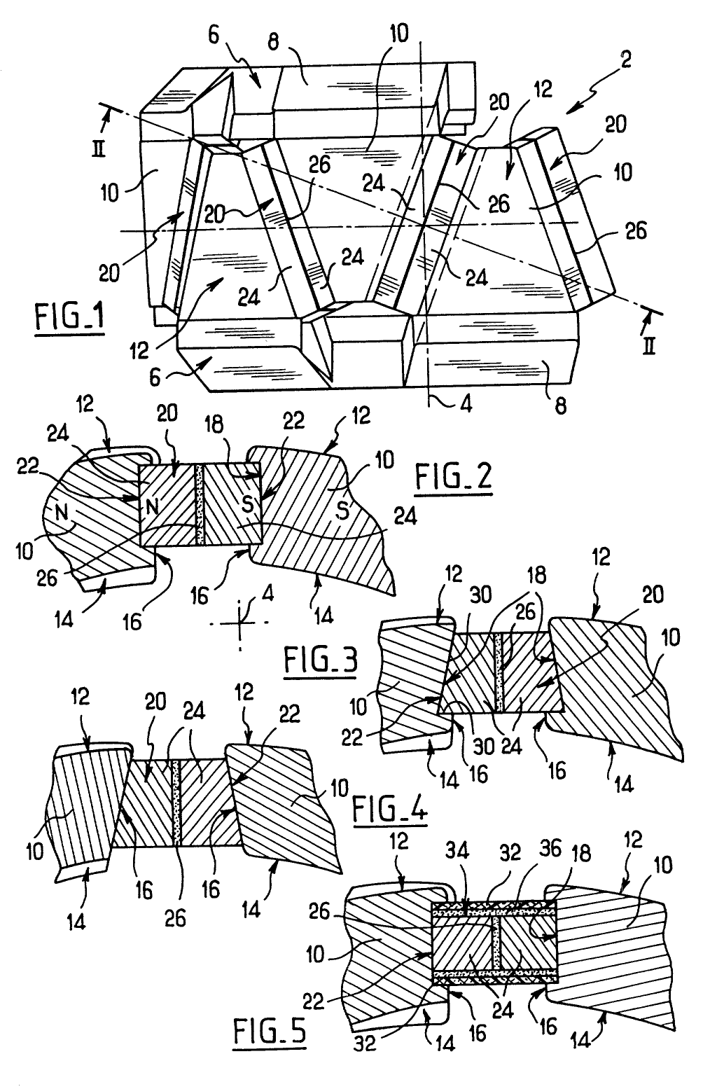

### DESCRIPTION OF THE PREFERRED EMBODIMENT

In the present embodiment, the electrical alternator for a motor vehicle according to the invention is intended to the cooled by water by being incorporated into the loop of the cooling circuit of the vehicle in a way which is known in itself. The alternator can be integrated, for example, for this purpose in series or in parallel with the radiator for heating the passenger compartment. Alternatively, the alternator may be of the type with internal ventilation.

The alternator includes a stator and a rotor 2 equipped with a shaft with axis 4, which are of a conventional type known in itself, for example from the document EP-0 762 617, except as far as the poles and the inter-pole magnets are concerned. The rotor includes two pole pieces or wheels 6 each comprising a disc-shaped plate 8 mounted coaxially on the shaft. The two plates 8 extend in coincidence and parallel to one another.

Each pole piece 6 includes claw-shaped poles 10, which are generally flat and triangular, extending from the plate 8 towards the other plate. The poles of the magnet wheels are mutually interlaced, so that the point of each pole 10 extends very close to the plate 8 of the other pole piece. Such an arrangement is known in itself.

The two magnet wheels 6 are associated with the respective North and South magnetic poles. Each pole 10 exhibits two respectively outer convex 12 and inner concave 14 circumferential faces, and two flat lateral faces 16 forming two of the sides of the triangle and contiguous with the circumferential faces. The lateral faces 16 of the poles 10 extend facing each other at a distance. Such an arrangement is known in itself.

In the present embodiment, each lateral face 16 exhibits a groove 18 or slot with a “U”-shaped profile, the groove having an axis extending along a longitudinal direction of the lateral face 16. The slot 18 exhibits a flat bottom and two sides perpendicular to it.

The rotor includes permanent magnets 20 here having a generally rectangular parallelepipedal shape and particularly a profile which is rectangular perpendicularly to a longitudinal direction of the magnet. Each magnet 20 is accommodated between the lateral faces 16 of two respective poles 10 with its lateral faces 22 in the slots 18 possibly with a layer of adhesive interposed at the bottom of the slots. Each magnet 20 is polarized North-South along a direction extending from one of its lateral faces to the other.

Each magnet 20 consists of two magnet parts 24 which, in this instance, are identical to each other in their shape and the dimensions and each have a rectangular parallelepipedal shape. These two parts 24 are separate from one another and fixed directly to one another by a layer of adhesive 26 constituting a material more flexible than that of the magnets. This layer here is flat and extends in a median longitudinal plane of the magnet 24 at mid-distance from the lateral faces 16 of the poles 10 and parallel to them. The flexible adhesive may be a silicone adhesive which is known in itself. It will advantageously comprise iron particles in order to provide good continuity of the magnetic field through the layer of adhesive 26. The magnet parts 24 may be ferrites or rare earths. The layer 26 at least partially takes up the play due to manufacturing tolerances, and absorbs the deformations due to the forces (centrifugal force) and to the heating effects appearing when the rotor is turning at high speeds.

The thickness of the layer of adhesive 26 will be negligible by comparison with the dimensions of the magnet 20 and has been exaggerated in the drawings for clarity of representation. This adhesive 26 will advantageously be identical to that interposed between the magnet and the poles at the bottom of the slots.

In the variant of FIG. 3, the groove 18 has a “V”-shaped profile with two branches 30 inclined with respect to one another. One of the branches 30 is generally parallel to the circumferential faces 12, 14 and perpendicular to the lateral face 16, while the other branch 30 is inclined with respect to the latter. The inclined branch here is that one of the two branches which is further from the rotor. Each magnet 20 this time has a trapezoidal shaped profile. The wider side of the two sides of the trapezium, which are parallel to each other, comes into contact with the non-inclined side 30 of the groove 18, and is therefore the side of the magnet which is closer to the axis 4. The flat median layer of adhesive 26 is perpendicular to the parallel sides of the trapezium.

In the variant of FIG. 4, the lateral faces 16 of the poles this time are devoid of slots and each is uninterrupted from one to the other of the circumferential faces 12, 14. They are inclined towards the shaft and therefore inclined with respect to one another. The magnets 20 are identical to those of FIG. 3. The sides of the trapezium which are not mutually parallel come into surface contact with the respective lateral faces 16 of the poles, with a layer of adhesive, not illustrated, being interposed.

The variant of FIG. 5 is similar to that of FIG. 2. The rotor includes a least one plate or strip 32 of flat rectangular shape produced from a material which is more flexible than the magnet, and comprising, for example, glass fibers embedded in a pre-impregnated plastic resin. This plate 32 is fixed to the outer circumferential face 34 of the magnet and reproduces its dimensions and its shape, with a layer of flexible adhesive 36 being interposed. It is itself also housed in the grooves 18 so that it is interposed between the magnet 20 and each of the grooves.

A similar plate 32 may be provided alternatively or additionally against the inner circumferential face of the magnet.

A strip could be provided in the variant of FIG. 3.

In the variant of FIG. 5 or that of FIG. 3, the strip or strips absorb the deformations and take up the play in directions other than the direction of take-up associated with the layer of adhesive 26 bonding the magnet parts 24.

For assembly, the strip or strips 32 can be fixed to the magnet 20, then the unit can be housed in the grooves 18 between the poles 10.

In contrast, it is possible alternatively to house the magnets 20 between the poles then to insert the strip or strips 32 into the grooves and to bond them at the same time to the magnet.

The layer of adhesive 26 bonding the two magnet parts 24 could extend in a plane locally parallel to the circumferential faces 13, 14 of the poles and perpendicular to the lateral faces 16.

1. An alternator for a vehicle, including two magnet wheels comprising poles in the form of interlaced claws and at least one magnet interposed between the poles, wherein the magnet comprises two separate parts fixed to one another by a layer of material which is more flexible than the magnet.

2. The alternator of claim 1, wherein the material comprises iron.

3. The alternator of claim 1, wherein the magnet extends between lateral faces of the associated poles, the layer of material extending along a plane parallel to the lateral faces of the poles.

4. The alternator of claim 1, wherein the layer of material extends at mid-distance from the associated poles.

5. The alternator of claim 1, wherein the layer of material extends along a median plane of the magnet, perpendicular to a direction of polarization of the magnet.

6. The alternator of claim 1, wherein the poles exhibit lateral faces in which grooves are formed in which the magnet is accommodated.

7. The alternator of claim 6, wherein the grooves have a “U”-shaped transverse profile.

8. The alternator of claim 6, wherein the grooves have a “V”-shaped transverse profile, one branch of the “V” being generally parallel to a circumferential face of the pole.

9. The alternator of claim 1, wherein the poles have circumferential faces and lateral faces each uninterrupted from one to the other of the circumferential faces and inclined towards the shaft of the alternator.

10. The alternator of claim 1 to 9, wherein the magnet has a rectangular profile perpendicularly to a longitudinal direction of the magnet.

11. The alternator of claim 1, wherein the magnet has a trapezoidal profile perpendicularly to a longitudinal direction of the magnet.

12. The alternator of claim 1, wherein the magnet is bonded to at least one of the poles by means of an adhesive identical to the said material.

13. The alternator of claim 1, which comprises several magnets, at least two of the magnets each comprising two separate parts.

14. The alternator of claim 13, wherein most, preferably all, of the magnets each comprise two separate parts.
